(19) United States
(12) Patent Application Publication
(10) Pub. No.: US 2013/0242583 A1
(43) Pub. Date: Sep. 19, 2013

(54) LIGHT RING OF VEHICLE LIGHT

(71) Applicant: MING-HSIEN TSAI, TAINAN (TW)

(72) Inventor: MING-HSIEN TSAI, TAINAN (TW)

(73) Assignee: JUN YAN AUTO INDUSTRIAL CO., LTD., TAINAN (TW)

(21) Appl. No.: 13/422,183

(22) Filed: Mar. 16, 2012

(51) Int. Cl. B62J 6/02; B60Q 1/04; B62J 6/00; B60Q 1/26; B60Q 1/00; B62J 6/04; F21K 2/00; B60Q 1/24

(52) U.S. Cl. 362/473; 362/510; 362/487

(57) ABSTRACT

A light ring of vehicle lights is revealed. The light ring includes a light collection ring and a light emitting source. The light collection ring is a transparent body while the light emitting source has a plurality of light emitting diode chips. The LED chips are disposed on a substrate orderly and compactly by bonding. The distance between two adjacent LED chips ranges from 1 mm to 3 mm. The substrate is coated with a phosphor adhesive layer and the LED chips are also covered by the phosphor adhesive layer. After being applied with a voltage, the LED chips emit light to energize the phosphor adhesive layer. Thus the phosphor adhesive layer releases energy in the form of light, entering an incident surface of the light collection ring to be emitted from an emission surface of the light collection ring. Thus a light ring with high brightness and uniform illumination is formed.

### BACKGROUND OF THE INVENTION

1. Field of the Invention

The present invention relates to a light ring of vehicle lights, especially to a light ring of vehicle lights with features of easy assembly, time saving and labor saving.

2. Description of Related Art

A day time running light (DRL, also daytime running light or daytime lighting system) is a lighting device of vehicles during daylight conditions. The research results show that daytime running lights on the front of vehicles ensure that cars in traffic are better visible to oncoming cars and reduce risk of accidents in daylight hours. Moreover, they improve vehicle visibility and increase safety performance. Thus all motor manufactures are required to have DRLs on new vehicles in Europe.

Refer to FIG. 1, a light ring of vehicle lights is revealed. A light emitting unit 41 and a cold cathode of a light ring unit 42 of a vehicle light 4 are connected to a vehicle power source. When the light emitting unit 41 is switched on to emit light, the cold cathode of the light ring unit 42 is also lighted up. When the vehicle is moving, vehicle visibility is improved due to auxiliary lights. However, cold cathode devices typically use a complex high-voltage power supply for creating the initial space charge and have high power consumption. Moreover, mercury contamination is a significant environmental problem and the cold cathode is usually affected by electromagnetic interference.

Refer to FIG. 2, another light ring of vehicle lights available now is revealed. The light ring of vehicle lights mainly includes a light emitting element 52 corresponding to each reflection unit 51 of a vehicle lamp 5. By the light emitting element 52, light is projected to the reflection unit 51 and is reflected by the reflection unit 51 to pass through a projecting edge of the light emitting element 52 and a diffusion surface 53. Thus a light ring is formed in the front of the vehicle light. However, while assembling the vehicle lights with such design, each light emitting element is arranged at the corresponding reflection unit respectively and then the light emitting elements are required to be connected in series or in parallel. This is time and labor-consuming.

### SUMMARY OF THE INVENTION

Therefore it is a primary object of the present invention to provide a light ring of vehicle lights with advantages of easy assembly, time-saving and labor-saving during the assembly.

In order to achieve the above object, a light ring of vehicle lights according to the present invention includes a light collection ring and a light emitting source. The light collection ring is a transparent body while the light emitting source consists of a plurality of light emitting diode (LED) chips. The LED chips are disposed on a substrate orderly and closely by bonding. The distance between two adjacent LED chips is ranging from 1 mm to 3 mm. The substrate is coated with a phosphor adhesive layer and the LED chips are also covered by the phosphor adhesive layer.

Once the light emitting source is applied with a voltage, the LED chips of the light emitting source emit light. The phosphor adhesive layer is excited by the light from the LED chip to generate energy as light. The light from the phosphor adhesive layer enters the incident surface to be emitted from the emission surface. Thus the light ring is used like DRL, providing warning effect and auxiliary illumination.

The incident surface of the light collection ring is disposed with refractive carved patterns in an orderly manner. The refractive carved patterns are in wave forms that rise and fall. The refractive carved patterns are in the form of sawtooth waves.

The light ring of vehicle lights is arranged circularly or linearly curved along with shapes of vehicle lights.

The light emitting source is formed by LED chips disposed on the substrate in a compact and orderly way by bonding while the distance between two adjacent LED chips is ranging from 1 mm to 3 mm. And the LED chips are also covered by the phosphor adhesive layer when the substrate is coated with the phosphor adhesive layer. Thus the plurality of LED chips and the substrate form an integrated part. Thus the light emitting source is assembled with the light collection ring directly. The assembly is easy and quick so that time and labor are saved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of a light ring of vehicle lights available now;

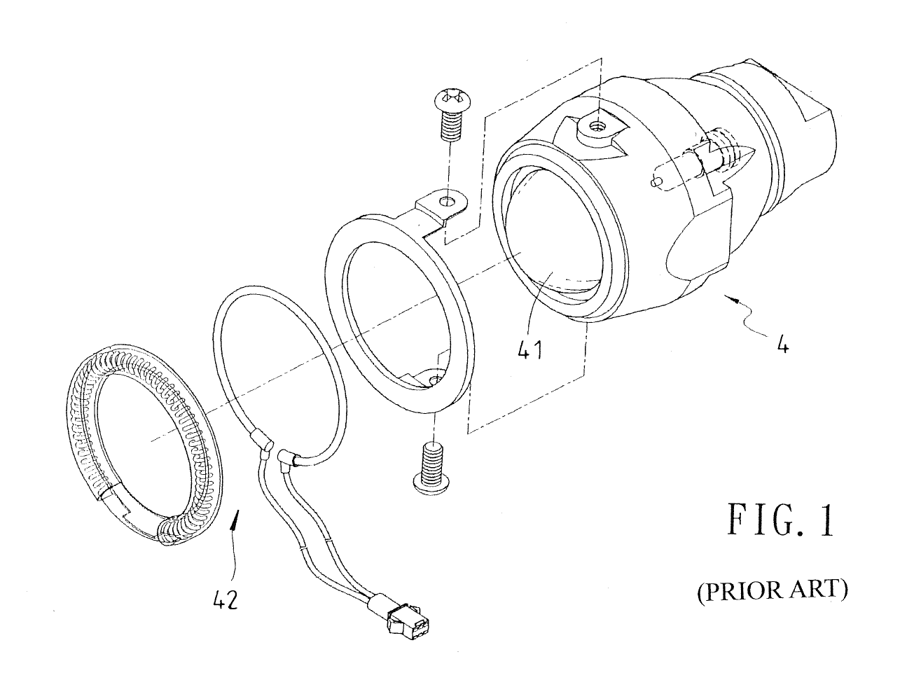

FIG. 2 is a schematic drawing showing a light ring of vehicle lights available now;

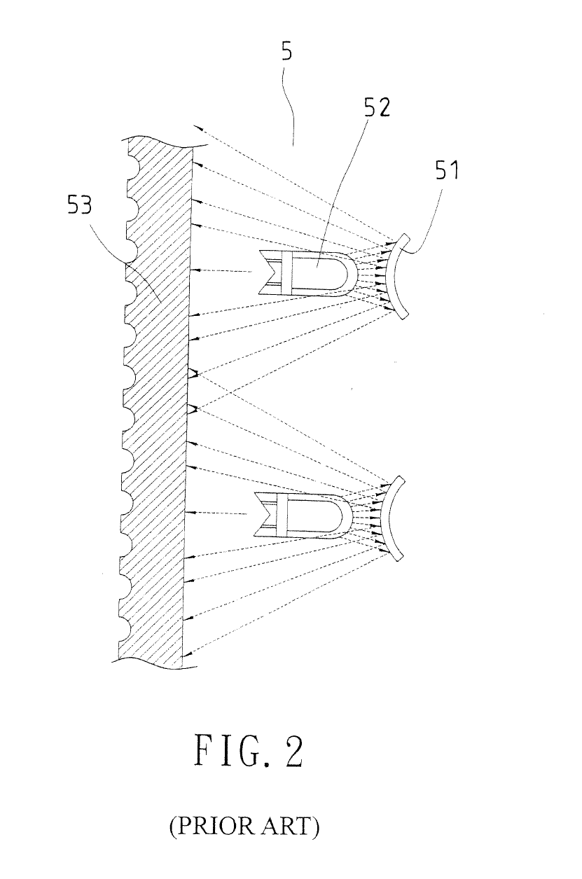

FIG. 3 is an explosive view of an embodiment of a light ring of vehicle lights according to the present invention;

FIG. 4 is a cross sectional view of an assembled embodiment of a light ring of vehicle lights according to the present invention;

FIG. 5 is a cross sectional view of a light source of an embodiment according to the present invention;

FIG. 6 is a schematic drawing showing an embodiment used in headlights, taillights or warning lights of vehicles according to the present invention.

### DETAILED DESCRIPTION OF THE PREFERRED EMBODIMENT

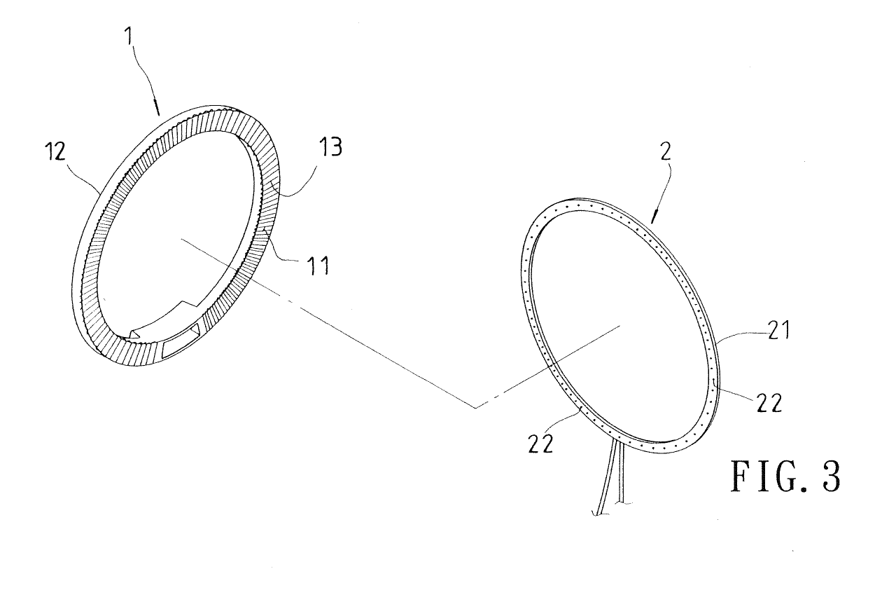

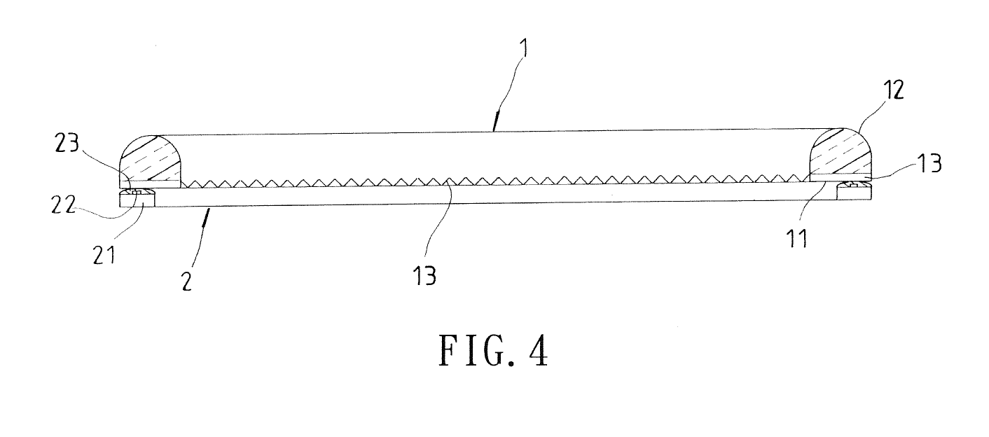

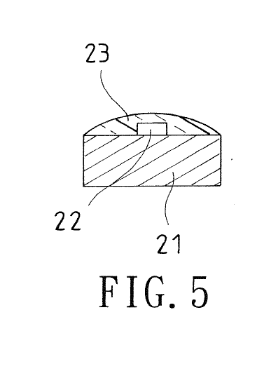

Refer to FIG. 3, FIG. 4 and FIG. 5, a light ring of vehicle lights of the present invention includes a light collection ring 1 and a light emitting source 2.

The light collection ring 1 is a transparent body that is composed of an incident surface 11 facing the light emitting source 2 and an emission surface 12 far away from the light emitting source 2.

The light emitting source 2 consists of a substrate 21 and a plurality of light emitting diode (LED) chips 22. The LED chips 22 are arranged at the substrate 21 in a neat and compact way by bonding. The distance between two adjacent LED chips 22 ranges between 1 mm to 3 mm. A phosphor adhesive layer 23 is covered over the substrate 21 and the LED chips 22 are also covered by the phosphor adhesive layer 23.

Moreover, refractive carved patterns 13 are disposed on the incident surface 11 of the light collection ring 1. And the arrangement of the LED chips 22 is corresponding to the refractive carved patterns 13. In a preferred embodiment, the refractive carved patterns 13 are arranged orderly.

After being applied with the voltage, the LED chips 22 on the substrate 21 of the light emitting source 2 emit light and the light acts on the phosphor adhesive layer 23. After being excited by the light, the phosphor adhesive layer 23 releases energy in the form of light. The radiated light is refracted by the refractive carved patterns 13 on the incident surface 11 of the light collection ring 1, entering the light collection ring 1 and emitted out from the emission surface 12. The distance between two adjacent LED chips 22 is only from 1 mm to 3 mm. Due to such dense and compact arrangement of the LED chips 22, a light ring with high brightness and uniform illumination is formed.

The refractive carved patterns 13 on the incident surface 11 of the light collection ring 1 are in wave forms that rise and fall, especially in sawtooth waves.

In the above embodiments, the light ring of vehicles lights is arranged circularly in headlights, taillights or warning lights of automobiles or motorcycles.

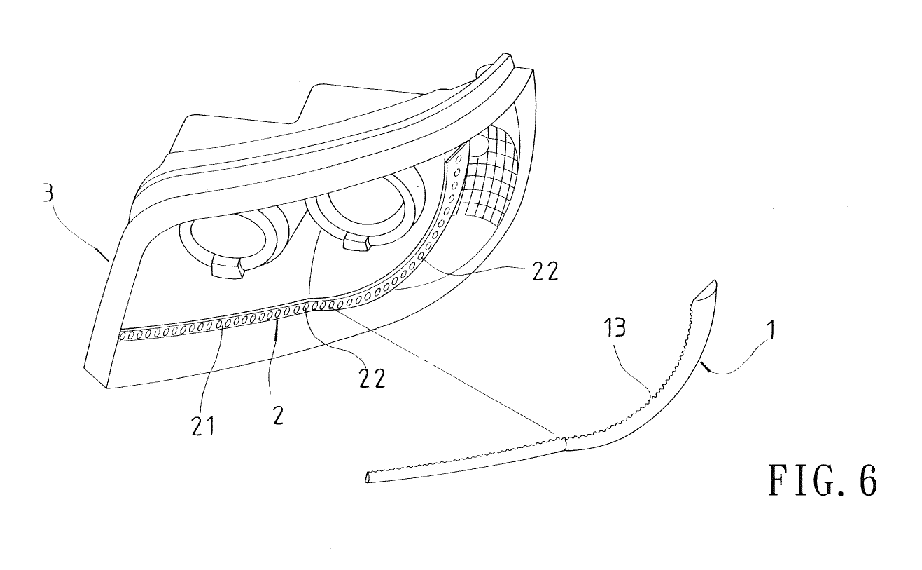

Refer to FIG. 6, in another embodiment, the light ring of vehicles lights is disposed linearly, like a strip curved along with the shape of headlights, taillights or warning lights 3 of automobiles or motorcycles.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A light ring of vehicle lights comprising: a light collection ring and a light emitting source;
wherein the light collection ring is a transparent body having an incident surface and an emission surface;
the light emitting source includes a substrate and a plurality of light emitting diode (LED) chips; the LED chips are disposed on the substrate compactly and orderly by bonding and a distance between two adjacent LED chips ranges from 1 mm to 3 mm; the substrate is covered with a phosphor adhesive layer and the LED chips are also covered by the phosphor adhesive layer; each LED chip is arranged correspondingly to the incident surface of the light collection ring.

2. The device as claimed in claim 1, wherein the incident surface is disposed with refractive carved patterns.

3. The device as claimed in claim 2, wherein the light ring of vehicle lights is disposed circularly or curvedly.

4. The device as claimed in claim 3, wherein the light ring of vehicle lights is arranged at headlights, taillights, or warning lights of automobiles and motorcycles.

5. The device as claimed in claim 2, wherein the refractive carved patterns are arranged orderly.

6. The device as claimed in claim 5, wherein the light ring of vehicle lights is disposed circularly or curvedly.

7. The device as claimed in claim 6, wherein the light ring of vehicle lights is arranged at headlights, taillights, or warning lights of automobiles and motorcycles.

8. The device as claimed in claim 5, wherein the refractive carved patterns are in wave forms.

9. The device as claimed in claim 8, wherein the light ring of vehicle lights is disposed circularly or curvedly.

10. The device as claimed in claim 9, wherein the light ring of vehicle lights is arranged at headlights, taillights, or warning lights of automobiles and motorcycles.

11. The device as claimed in claim 5, wherein the refractive carved patterns are in sawtooth waves.

12. The device as claimed in claim 11, wherein the light ring of vehicle lights is disposed circularly or curvedly.

13. The device as claimed in claim 12, wherein the light ring of vehicle lights is arranged at headlights, taillights, or warning lights of automobiles and motorcycles.

14. The device as claimed in claim 1, wherein the light ring of vehicle lights is disposed circularly or curvedly.

15. The device as claimed in claim 14, wherein the light ring of vehicle lights is arranged at headlights, taillights, or warning lights of automobiles and motorcycles.
